(19) United States
(12) Patent Application Publication
(10) Pub. No.: US 2005/0213351 A1
(43) Pub. Date: Sep. 29, 2005

(54) Light-Guiding structure for floor-pan edge of a car

(76) Inventor: Chang-An Yang, Hsi Chih City (TW)

Correspondence Address: Leong C. LEI, PMB 3 1008, 1867 Ygnacio Valley Road, Walnut Creek, CA, 94598, US

(21) Appl. No.: 10/806,283

(22) Filed: Mar. 23, 2004

(51) Int. Cl. G01D 11/28

(52) U.S. Cl. 362/633; 362/27; 362/511; 362/545

(57) ABSTRACT

A light-guiding structure for floor-pan edge of a car is disclosed. A LED is used as the light source to project light source at the two ends of the elongated thin light-guiding plate. The bottom section of the light-guiding material is provided with a reflective matte surface which can focus and reflect light. The reflective matte surface corresponds to each separate embossed character on the transparent plate surface which respectively refracts the reflected light so that the reflected light is focus on the surface of the embossed character. This will provide stronger light with the lesser light source as an ornamental to the floor-pan edge of a car.

### BACKGROUND OF THE INVENTION

(a) Technical Field of the Invention

The present invention relates to a floor-pad edge light-guiding plate, and in particular to a light-guiding structure employing micro LED as light source to project light source at the two ends of the elongated thin light-guiding plate. The bottom section of the light-guiding material is provided with a reflective matte surface which can focus and reflect light. The reflective matte surface corresponds to each separate embossed character on the transparent plate surface which respectively refracts the reflected light so that the reflected light is focus on the surface of the embossed character. This will provide stronger light with lesser light source as an ornamental to the floor-pan edge of a car.

(b) Description of the Prior Art

Published Patent No. ZL 98225145.9 entitled “EMBOSSED LED STRUCTURE USED IN CAR” discloses the use of cold light as light source for pedal plate for door panel. An equivalent structure using LED as light source is available in the market. FIG. 1 depicts the structure comprising a pedal plate with through hole word a1 on an opaque surface a, a transparent plate b with embossed character b1 and the bottom section of the transparent plate b being shallow recess b2 contained by a dispersion film c installed with a plurality of micro LED f1 as light source. The light guiding plate d is made from light-guiding material and the bottom face is light-guiding matter matte surface d1. Beneath the light-guiding plate d or surrounding the plate d, there are reflective plate e. The light-guiding matte surface d1 is constituted from dots and recesses and light will be focused on the reflective matte surface and reflected to the disperse film c and through the transparent plate b so that the characters on the surface a can be seen. The reflective matte surface d1 is used for reflecting light source and the intensity of the reflected light of the entire light-guiding plate is even. The effect of this conventional structure is similar to that of the published patent no. ZL 98225145.9.

This conventional structure employs background light used in notebook computer on the structure disclosed in the published patent no. ZL 98225145.9. The cost of material is higher than that used in cold light plate and the fabrication process is very complicated.

Accordingly, it is an object of the present invention to provide a light-guiding structure for floor-pan edge of a car, where a LED is used as the light source to project light source at the two ends of the elongated thin light-guiding plate. The bottom section of the light-guiding material is provided with a reflective matte surface which can focus and reflect light. The reflective matte surface corresponds to each separate embossed character on the transparent plate surface which respectively refracts the reflected light so that the reflected light is focus on the surface of the embossed character. This will provide stronger light with lesser light source as an ornamental to the floor-pan edge of a car.

### SUMMARY OF THE INVENTION

An object of the present invention is to provide a light-guiding structure for floor-pan edge of a car, wherein a minimum light source is used to provide maximum effect so that the embossed characters on the edge of the floor-pan of the car are clearly seen.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded perspective view of a conventional art.

FIG. 2 is an exploded perspective view of a light-guiding structure for floor-pan edge of a car of the present invention.

FIG. 3 is a sectional view along the end section of the present invention.

FIG. 4 is a partial exploded perspective view of the present invention.

FIG. 5 is a sectional view along the end section of another preferred embodiment of the present invention.

FIG. 6 is a partial exploded perspective view of another preferred embodiment of the present invention.

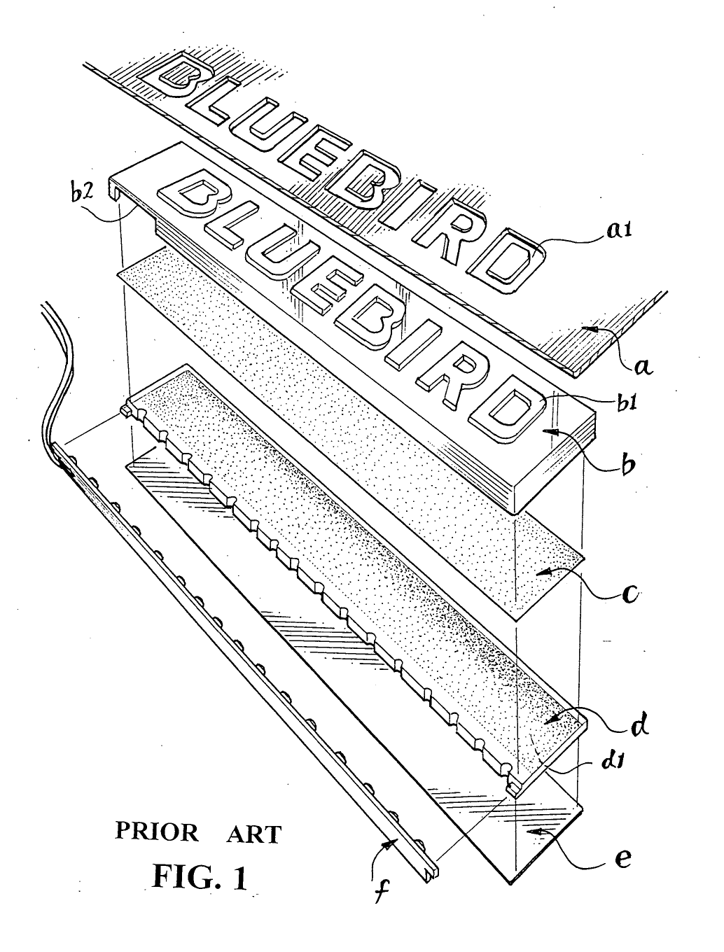

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

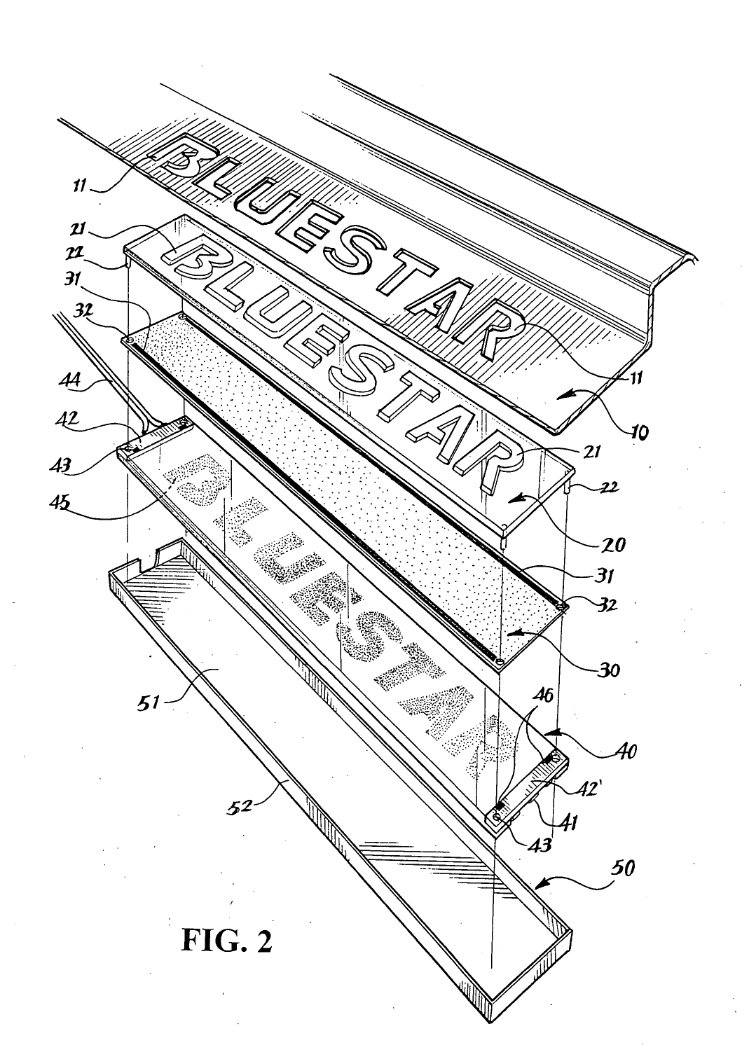

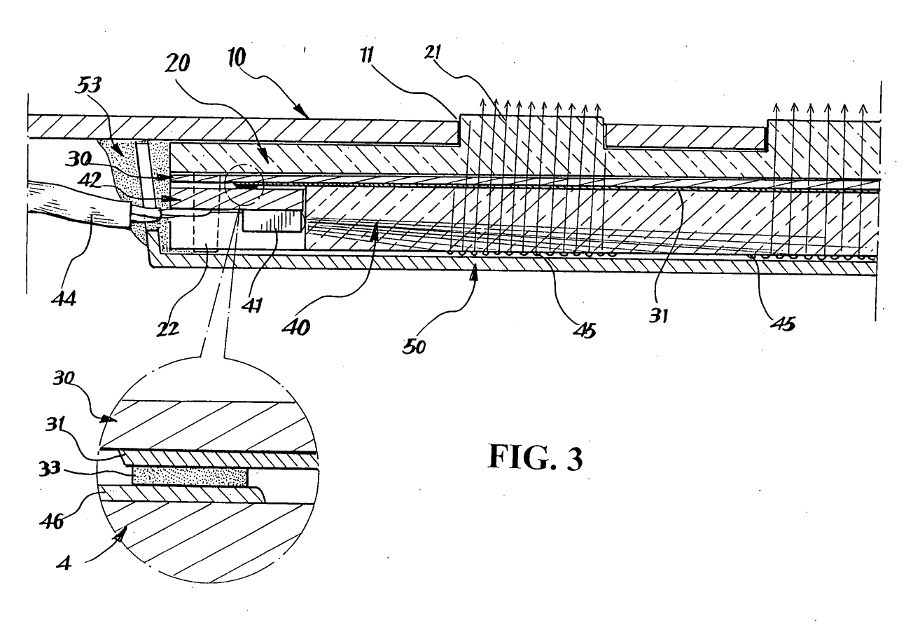

Referring to FIGS. 2 and 3, there is shown a light-guiding structure for floor-pan edge of a car comprising an opaque plate 10 with through hole 11 having characters, a transparent plate 20 with embossed characters 21, a disperse film 30 mounted with conductive material 31, a light-guiding plate 40 having two ends mounted with a plurality of LEDs 41 as light sources 42, 42′ and having a light reflective matte surface 45 with a bottom section corresponding to character used as a water resistant cover and a seal cap 50 for reflective light source.

Referring to FIG. 7, the components mentioned above are combined in sequence and then mounted onto the floor pan beneath the door panel. A 12V DC battery is then mounted and the embossed character 21 is formed on the panel 10 as shown in FIG. 7. The panel 10 is made from a thin metal plate or a plastic material and on the surface of the panel there are characters formed from a plurality of holes 11.

The transparent plate 20 is made from plastic material and embossed characters 21 are formed above the surface of the panel 10. The two ends at the bottom section of the plate body of the transparent plate 20 are provided with two positioning pegs 22 for securing the light-guiding plate 40 via the disperse film 30. The positioning peg 22 is exposed beyond the end section and is then welded to form a securing end.

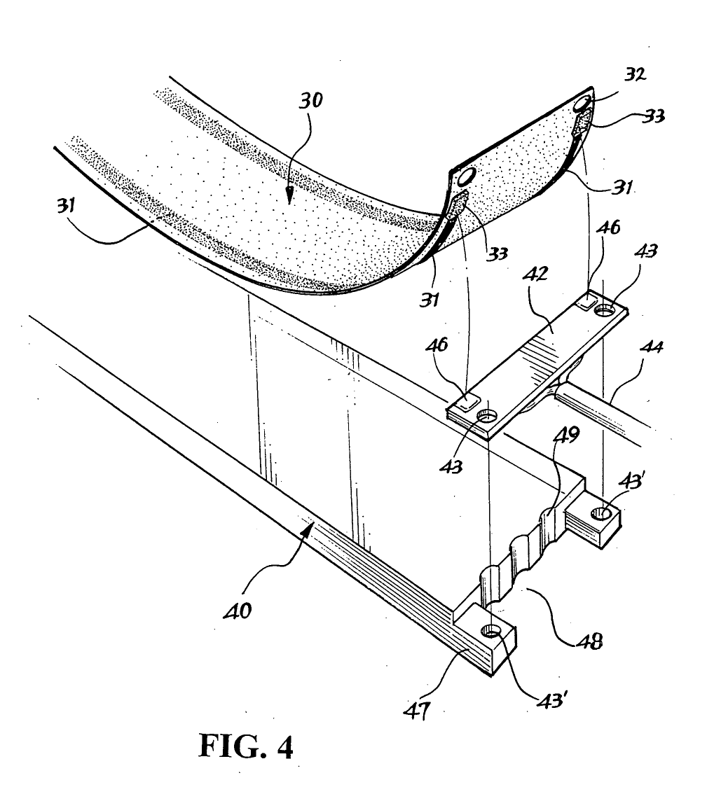

Referring to FIGS. 3 and 4, the disperse film 30 is positioned between the transparent plate 20 and the light-guiding plate 40 and the reflecting light of the light-guiding plate 40 is dispersed to form into a light-emitting region. The four corners of the disperse film 30 are provided with positioning holes 32 for the passage of the positioning peg 22. The two sides of the bottom face are each provided with electric conductive material 31 across the bottom face of the disperse film 30 so that the two ends of the conductive material 31 are in conduction with the connection point 46 of the light source bodies 42, 42′.

As shown in FIG. 2, the bottom face of the light guiding plate 40 corresponding to the embossed characters 21 is formed into reflective matte face 45, and the reflective matte pace 45 is formed from a plurality of fine protrusions or recesses. The matte face 45 positioned close to the light source bodies 42, 42′ (brighter region) has looser protrusions and has concentrated protrusions at the remote side of the light source bodies 42, 42′ so as to distribute light equally to the each of the characters. As an example, among the “BLUE STAR”, the protrusions of B and R are looser and that at E and S are concentrated.

FIG. 4 is an exploded view of the panel, wherein the two ends of the light guiding plate 40 are provided with recess 48 to install the light source body 42, the wall of the recess 48 is provided with light-guiding curvature 49 corresponding to the LED 41. The two sides of the recess 48 are provided with a protruded arm 47 and is provided with a positioning hole 43 to correspond to the through hole of 43 of the light source body 42 and the positioning peg 22 allowing the peg 22 to pass through therebetween.

The seal cap 50 is made from thin metal and is formed as an unit. Silica gel 53 seals the bottom of the panel 10.

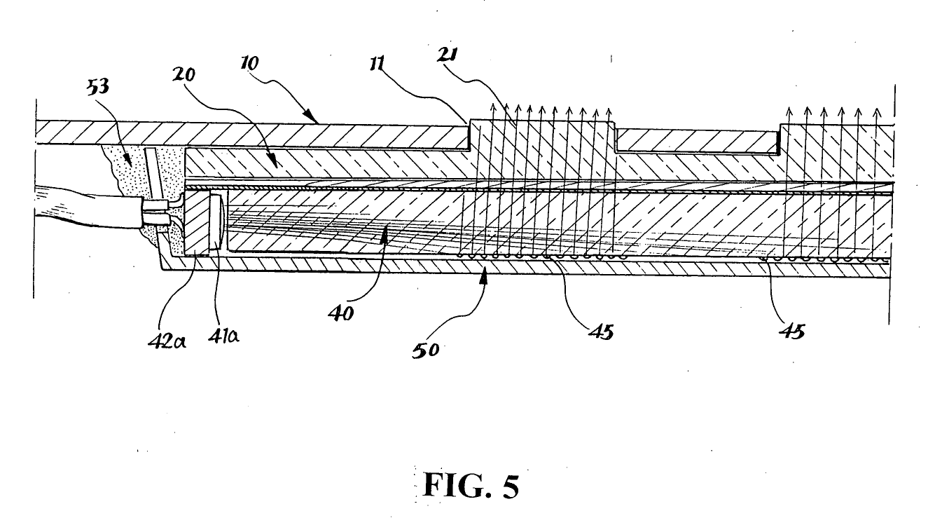

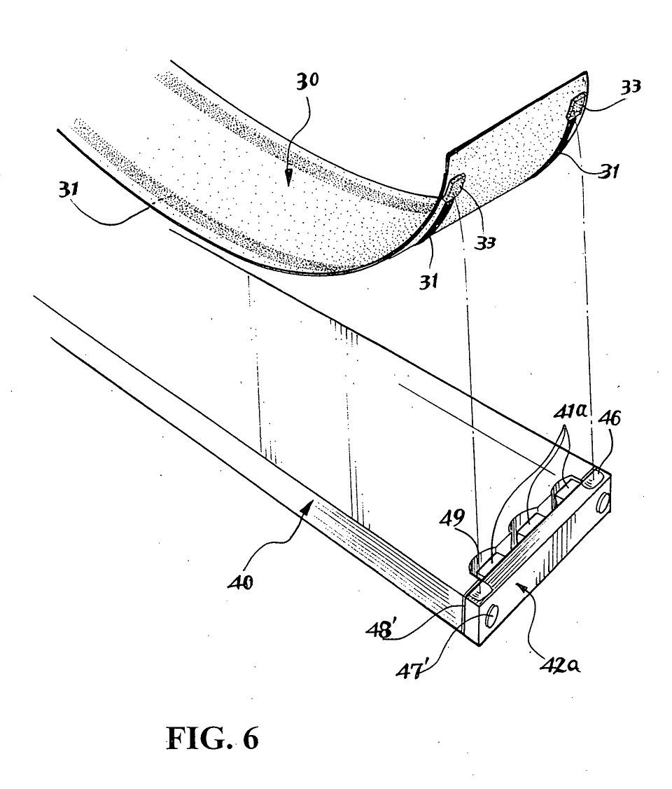

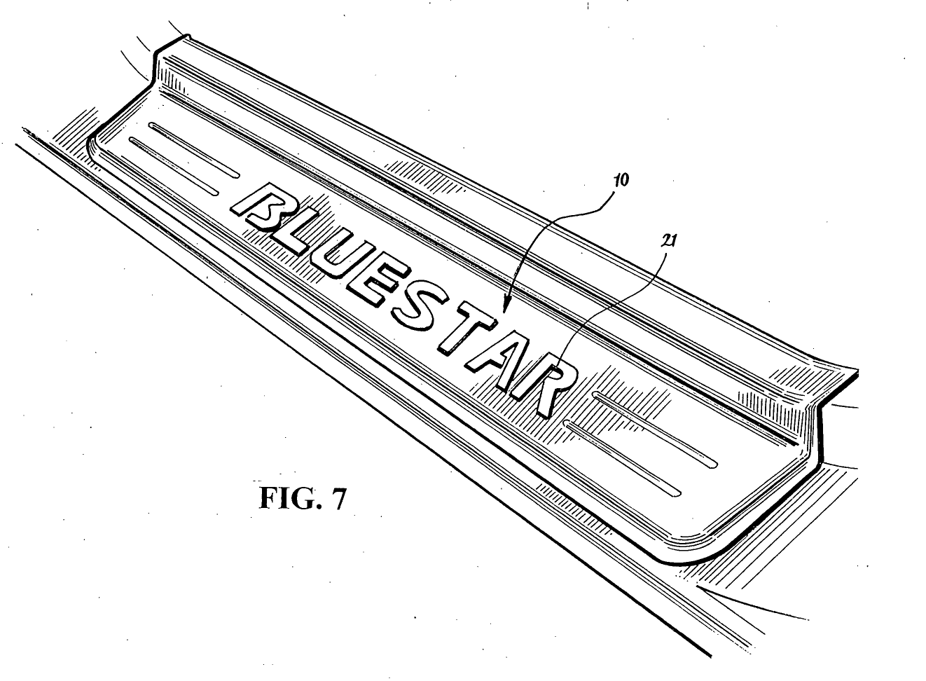

FIGS. 3 and 4 is an example employing side projection as light source body 42 and FIGS. 5 and 6 is an example employing front projection as light source.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A light-guiding structure having a light-guiding plate for the floor-pan edge of a car employing micro LEDs as light source body and having projection light source at the two ends of the thin light-guiding plate and the bottom section of the light-guiding plate being a reflective matte surface for focusing reflected light, characterized in that an opaque plate on the door panel is provided with characters formed from through holes and the bottom of the plate is mounted with a transparent plate with embossed characters and the embossed characters are in aligned with the through hole characters of the opaque plate, and the bottom section of the transparent plate is mounted with a disperse film with a transparent light-guiding plate at the bottom thereof, and the two ends of the light-guiding plate are mounted with a light source body, the bottom section of the light-guiding plate is provided with a separated reflective matte face corresponding to the embossed characters, and a covering cap covers the light-guiding plate, the light source body, the disperse film to the bottom face of the opaque plate.

2. The light-guiding structure of claim 1, wherein the two ends of the bottom section of the transparent plate are protruded with a positioning peg, passing through the disperse film and the light-guiding plate or light source body for positioning.

3. The light-guiding structure of claim 1, wherein the two sides of the bottom face of the disperse film are provided with electric conductive material across the bottom face of the disperse film and the two ends of the conductive material are electrically connected to the connection point of the light source body at the two ends of the light-guiding plate.

4. The light-guiding structure of claim 1, wherein the bottom face of the light-guiding plate corresponding to the position and the shape of the embossed characters is provided with a separate reflective matte surface forming from micro protrusions or recesses.

5. The light-guiding structure of claim 1, wherein the cover cap is made from thin metal plate formed as a unit having the shape similar to the light-guiding plate but of larger bottom surface with upright thin wall for covering the transparent plate, the disperse film and the light-guiding plate and is mounted below the door panel using silicon gel.
